(19) United States
(12) Patent Application Publication
(10) Pub. No.: US 2003/0233639 A1
(43) Pub. Date: Dec. 18, 2003

(54) Programming interface for a reconfigurable processing system

(76) Inventor: Tariq Afzal, Union City, CA (US)

Correspondence Address: Robert E. Krebs, THELEN REID & PRIEST LLP, P. O. BOX 640640, SAN JOSE, CA, 95164-0640, US

(21) Appl. No.: 10/166,026

(22) Filed: Jun. 11, 2002

(51) Int. Cl. G06F 9/45

(52) U.S. Cl. 717/145

(57) ABSTRACT

A method for automatically compiling computer program written in a high level programming language into a program for execution by a reconfigurable processing system. The method comprises automatically determining a set of instructions to be executed by the reconfigurable processing system that will result in the optimization of the execution of the computer program. Next, executable code is generated for the reconfigurable processing system with the instructions. In the preferred embodiment, the high level programming language provides a development environment which utilizes concepts from both flexible and fixed hardware programming.

### BACKGROUND OF THE INVENTION

1. Field of the Invention

The present invention relates generally to programming interfaces and more particularly to a programming interface for a reconfigurable processing system.

2. Status of the Prior Art

A programmer will typically utilize a high level programming interface for creating applications to be run on a desired device. The high-level programming interface is device specific. For instance, programmers wishing to program flexible hardware such as FPGA's utilize device-specific hardware modeling languages that are synthesized for the flexible hardware design. Such languages are EDA and Verilog, and allow the designer to perform synthesis, timing, simulation and waveform viewing, as well as determine data read/write and register/signals. The hardware design cycle takes into account resource allocation, propagation delays, placement and routing. The cycle typically has modeling, creating a virtual circuit and creating a physical circuit after appropriate verification.

On the other hand, if the designer is creating applications for fixed hardware such as digital signal processors, the designer will use a software programming language that is compiled and run on the processor. The programmer will use C/C++ or ASM to debug and compile the program that is to be run on the processor. Software programming contains a built-in sequence provided to the programmer so that there is no separation of control flow and data flow descriptions. The structure of the program can convey much information. The software development cycle typically includes editing, compiling, and debugging. It will be evident that the skills necessary to program the flexible hardware (i.e., FPGA) are not transferable with the skills necessary to program fixed hardware.

Another type of programmable hardware is the reconfigurable communications processor (RCP). The RCP is an ASIC that allows the developer to reprogram the processor for different applications. The RCP includes a CPU core, PCI and memory interfaces, and a reconfigurable processing fabric (RPF) that can be reprogrammed according to the needed application. Using time-based functional multiplexing, a series of algorithms are mapped onto the RPF which is reconfigured in a few μsec. The RCP requires the programming skills from both the fixed hardware and flexible hardware sets.

The present invention provides a programming interface for the RCP which allows the programmer to develop applications for the RCP utilizing the skills from the fixed and flexible hardware sets. The present invention provides an interface that bears resemblance to the programming environment of digital signal processors by providing less architectural detail, less programming complexity, and increased efficiency, ease of use, and productivity. Furthermore, the present invention provides an interface having a software-like perspective. For instance, the hardware design is through a software environment and the hardware is debugged from software code. Accordingly, the present invention provides a programming interface to the RCP which allows the developer to create applications in a familiar environment.

### BRIEF SUMMARY OF THE INVENTION

Background of the Invention

In accordance with the present invention, there is provided a computer implemented method for the automatic compilation of a computer program written in a high level programming language into a program for execution by a reconfigurable processing system with a processor. The method comprises automatically determining a set of instructions to be executed by the reconfigurable processing system that will result in the optimization of the execution of the computer program written for execution by the processor. Furthermore, the method comprises generating executable code for the reconfigurable processing system with the instructions.

The set of instructions comprises generating a set of data computation commands that are processed by the reconfigurable processing system. Furthermore, the set of data computation commands are generated for operation on the processor of the reconfigurable processing system in order to perform computations. The set of instructions comprises a set of data storage and access commands for loading and storing instructions onto the reconfigurable processing system. The data storage and access commands instruct how data is to be supplied to the processor of the reconfigurable processing system. The commands may be load/store instructions for the processor. Furthermore, the generated data storage and access commands may include commands which operate address generators, comparators, interconnects, rams and registers of the reconfigurable processing system.

### BRIEF DESCRIPTION OF THE DRAWINGS

These, as well as other features of the present invention will become more apparent upon reference to the drawings wherein:

FIG. 1 is a block diagram showing the components of a Reconfigurable Communications Processor (RCP).

FIG. 2 is a block diagram showing a programming interface for RCP of FIG. 1.

FIG. 3 is a block diagram showing a complex multiply operation.

FIG. 4 is a diagram illustrating a load instruction for the interface of FIG. 2.

FIG. 5 is a diagram illustrating a custom load instruction for the interface of FIG. 2.

FIG. 6 is an example of a code listing for the interface of FIG. 2.

### DETAILED DESCRIPTION OF THE INVENTION

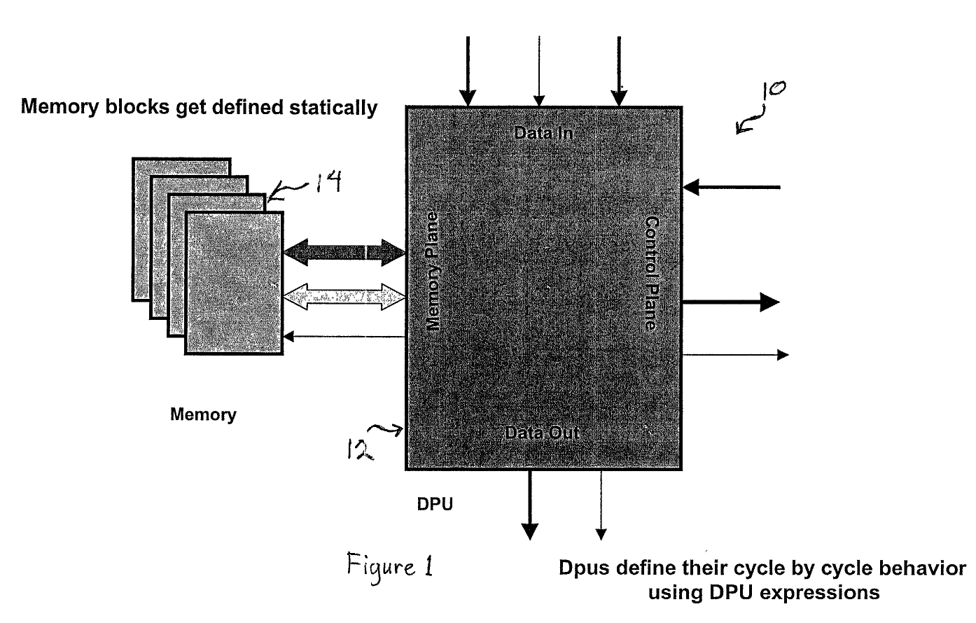

Referring now to the drawings wherein the showings are for purposes of illustrating a preferred embodiment of the present invention only, and not for purposes of limiting the same, FIG. 1 shows the building blocks of a RCP 10. The RCP 10 has at least one datapath unit (DPU) 12 which processes memory blocks 14. Each of the memory blocks 14 is able to program the datapath unit 12 for a desired application. The DPU 12 defines its cycle by cycle behavior using DPU expressions. Data and control signals are inputted to the DPU 12 and data is then outputted thereby. The programming interface of the present invention generates the set of executable instructions that are operable by the DPU 12.

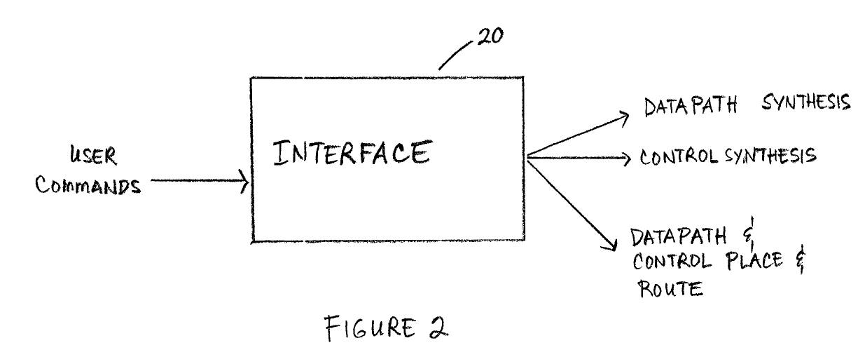

Referring to FIG. 2, the interface 20 of the present invention provides a developer the necessary tools in a high-level assembly language for expressing, in a concise and accurate way, algorithms that yield a mapping to the RCP 10. The interface 20 takes user commands written in the high-level assembly language and derives datapath synthesis, control synthesis, and datapath and control place and route for the RCP 10. In this respect, the high-level assembly language for the interface 20 supports data computation commands such as ADD, SUB, XOR, MIN, etc . . . (opcodes for the RCP 10). Furthermore, the high-level assembly language supports data and storage access (terminals of data computation) and control flow instructions. The interface 20 is additionally concurrent (supports parallelism) and symbolic (tries to preserve algebraic syntax). The high-level language is a single-assignment language and is supported by control flow constructs.

The high-level language for the interface 20 has various data types. Some of the common data types are:

| | |
|---|---|
| var foo | //foo is a named DPU 12, it also refers to |
| | the oreg of the dpu. |
| const constVar = 0xff00 | //defines a constant, does not have a fabric |
| | allocation. |
| gvar globVar; | //named horizontal and global net |
| cvar addr_ctrl; | //defines state variable, which can be used |
| | for predication, can be initialized. |
| var 32 sample [24] | //defines a memory array 32 bit wide and |
| | 24 deep. |

It will be recognized that other data types can be defined and recognized by the interface 20 as needed.

The interface 20 abstracts the whole DPU 12 as a single operator as opposed to being a collection of shifter, mask and alu operators. The general form of the DPU expression is:

[predicate] var =

(var_a MASKOP const)

ALUOP

((var_b SHIFTOP const) MASKOP )

[SLICE, TILE, DPU];

“A” and “B” arms of the ALUOP are strictly positional. Some representational examples of DPU expressions are:

result =y;
result = foo + bar;
result = (foo & oxff)\hat{ }(bar | 0xa);
result = (a & 0xf0) SUB (LRS (b,5) | 0xcafe);
result = foo ADD bar, flagConf = co;
result = foo ADD bar, flagSrc = prevDpu;
result = a XOR b, flagConf=eq;
result = null PASSB SWAP (iq_data);
result = areg SADD breg, areg = adata;
result = result, breg = bdata.

The interface 20 abstracts special DPU modes by making them available as synthetic instructions. For example:

mult = areg MPYLH breg, ...
result = null LFSR null, flagSrc=serIn.

Furthermore, the DPU expressions may be literal operations which have pre-defined meanings:

result=12p add 14n.

In the high-level language for the interface 20, programmers can specify a parallel instruction block with a series of expression separated by “∥” (parallel bars). A parallel instruction block informs the interface 20 that all of the instructions in the block can be enabled in the same clock. Though all instructions in a parallel instruction block can begin their execution at the same clock, they need not finish at the same clock. The “;” character marks the end of a parallel instruction block. An example of the syntax for a parallel instruction block is:

a=b ADD c ∥ count=count ADD 1 ∥ j=j ADD4;

It is also possible to define predicated DPU expressions which are useful in coding software pipelines. Predicated DPU expressions are expressions which only IFF there predicate is true. Some examples are:

| | |
|---|---|
| [coefLoad] | a = areg MPYLL breg, breg = c0 |
| [!coefLoad] | a = areg MPYLL breg |

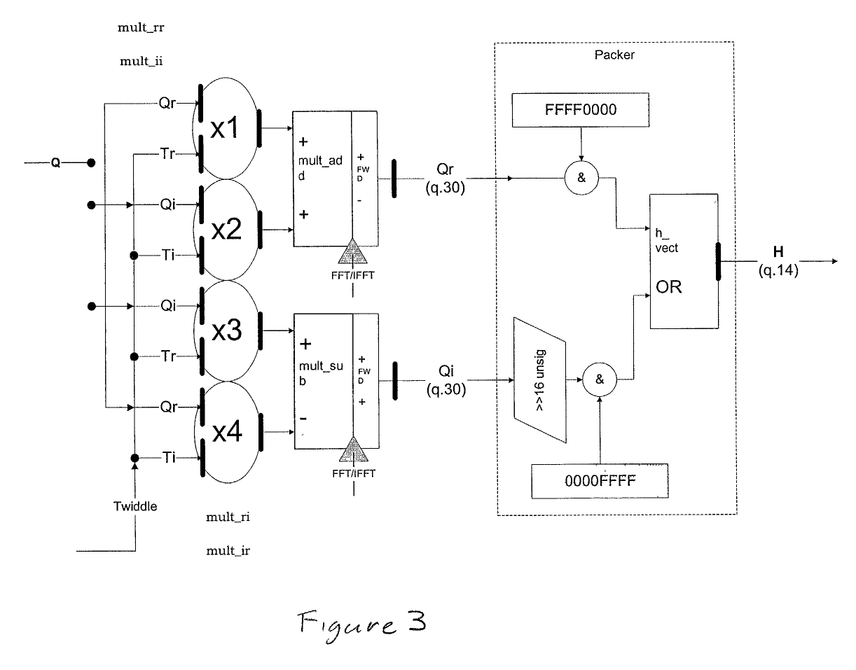

Referring to FIG. 3, a hardware model for a complex multiply command is shown. The corresponding software code for creating the command using parallel instructions with the high-level language blocks is shown below:

kernal ComplexMultiply (twiddle, data, output)
in var twiddle;
in var data;
out var output;
{

| var mult_rr, mult_ii, mult_ri, mult_ir; // four multipliers | |
|---|---|
| var mult_add, mult_sub; | |
| var h_vect; | |
| /* Four multiplies */ | |
| | mult_rr = areg MpYHH breg, areg = data, breg = twiddle |
| \|\| | mult_ii = areg MpYHH breg, areg = data, breg = twiddle |
| \|\| | mult_ri = areg MpYHH breg, areg = data, breg = twiddle |
| \|\| | mult_ir = areg MpYHH breg, areg = data, breg = twiddle |
| /*Addition and subtraction*/ | |
| \|\| | mult_add = mult_rr ADD mult_ii |
| \|\| | mult_sub = mult_ri SUB mult_ir |
| /*Q15 packing */ | |
| \|\| | h_vect = (mult_add & 0xffff0000) |

or ((mult_sub ARS 16) & 0xffff;

The interface 20 is configured such that if the behavior for the DPU is not specified in a parallel instruction block (PIB), the DPU 12 will recirculate the previous value automatically. However, it is possible to change the default behavior of the DPU 12. For example,

| | a = b ADD c |
|---|---|
| \|\| | count = count ADD 1 |
| \|\| | j = j ADD breg, defaultInsn = true; |
| | // j will be incremented by 4 every clock. |
| | a = b SUB c |
| \|\| | count = count ADD breg; |

As previously mentioned, the interface 20 is operative to provide for data storage commands. The interface 20 provides mechanisms to build custom versions of instructions which are equivalent to load/store instructions in digital signal processors. The types of memory access are array walk, circular buffer, and random access (e.g., table lookup, interpolation, and bit reverse addressing).

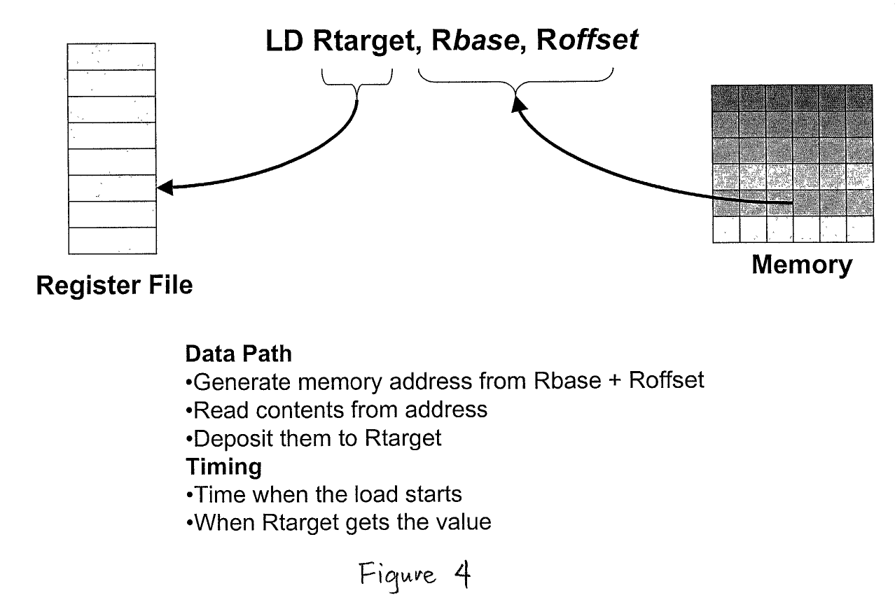

Referring to FIG. 4, the anatomy of a load instruction is shown. The syntax for the load instruction is:

LD Rtrarget, Rbase, Roffset.

The datapath will generate a memory address from Rbase+Roffset. The contents from the address are read and deposited to Rtarget. The timing begins when the load starts until Rtarget gets the value.

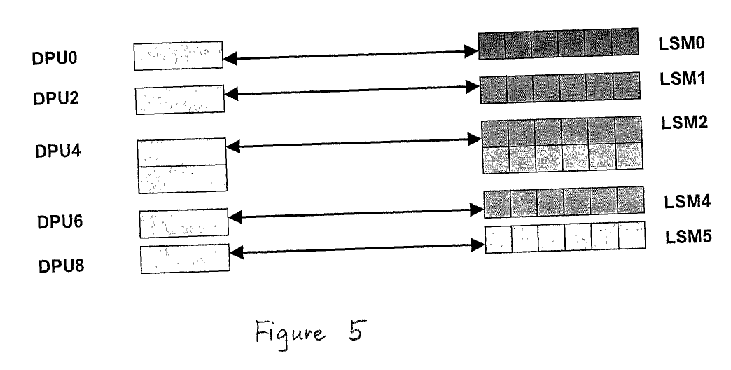

Referring to FIG. 5, custom load instructions are depicted. In such instances, transfers may occur between specific locations and specified DPU'S. For instance, DPU 6 and LSM 4 may have transfers occurring therebetween. An example for building a custom load instruction is shown below:

var xLoad;
var32 x[10];
//Definition of address generator
agen xAgen (type = simple start = 0, end = 40, stride = 4);
//Build a load instruction which reads lsm x and deposits the result in
xLoad load x(dpu=xload, agen=xAgen);
//various flavors of load available

| | |
|---|---|
| load(x); | //Send next address to LSM and complete and earlier |
| | LSM read |
| loadi (x); | //Only send out next address to LSM |
| loadc (x); | //Only complete an earlier started LSM read |
| loadr (x); | //Reset address generator |

As previously mentioned above, the programmer can also define control variables using the interface 20. The control variables can have the following expressions:

cvar ctrlVar, ctrl[2], ctrlGroup[3], a, b, c;
var dpuVar;
ctrl Var := anotherctrlVar;
ctrl Var := dpuVar[flag];
ctrl Var := a.b.c;

| | |
|---|---|
| ctrlGroup[1] | := dpuVar[1]; |

//ctrlGroup[1] = dpu Var[1]; ctrlGroup[2] = dpu Var[3]; ctrlGroup[3]=
dpu Var[4]

| | |
|---|---|
| ctrlGroup | := dpu Var(mask = 0xd); |

//Sum of product form
//if(ctrl==0){ctrl=1}else if(ctrl==1)[ctrl=2}else if(ctrl==2){ctrl=3}

| | |
|---|---|
| ctrl | :=(ctrl==0).1 + (ctrl==1).2 + (ctrl==2) .3; |

//Logical operations

| | |
|---|---|
| ctrl | := pnbit_1\hat{ }pnbit_2\hat{ }pnbit_3\hat{ }pnbit_4 |

Additionally, predicates for control conditions can be defined that must be met before the “predicated instruction” can be executed in a particular parallel instruction block. The predicated instruction is effective in the same clock cycle. For example:

[x.y.z]
[a.!b.c]
[(state==5).!w]
[state[1].state[3].state[4]]

Another example of a predicated expression is:

Some_state:

[addr_ctrl] addr = addr + 32;
[!addr_ctrl] addr = zero;

In addition to the foregoing, control flows can be defined using the interface 20. The control flows can define sequencing states for the RCP 10 that determine the next state to run which is effective in the next clock cycle. Furthermore, unconditional branches (i.e., goto loopOver;) and conditional branches may be defined. An example of a conditional branch to be used with the interface 20 is:

| | |
|---|---|
| if (x.y.z) | goto first_state |
| else if ((condition==2)) | goto second_state |
| else | goto third_state; |

In addition to the foregoing, the interface 20 can be used to define function forks which enable hierarchical design. For instance, the programmer can use function forks to initiate another kernel with optional arguments from the current kernel. Of course, the function fork can be predicated. Some examples of function forks are:

radix2bfy rdx (data1, data2)

[first_time] doSomething( )

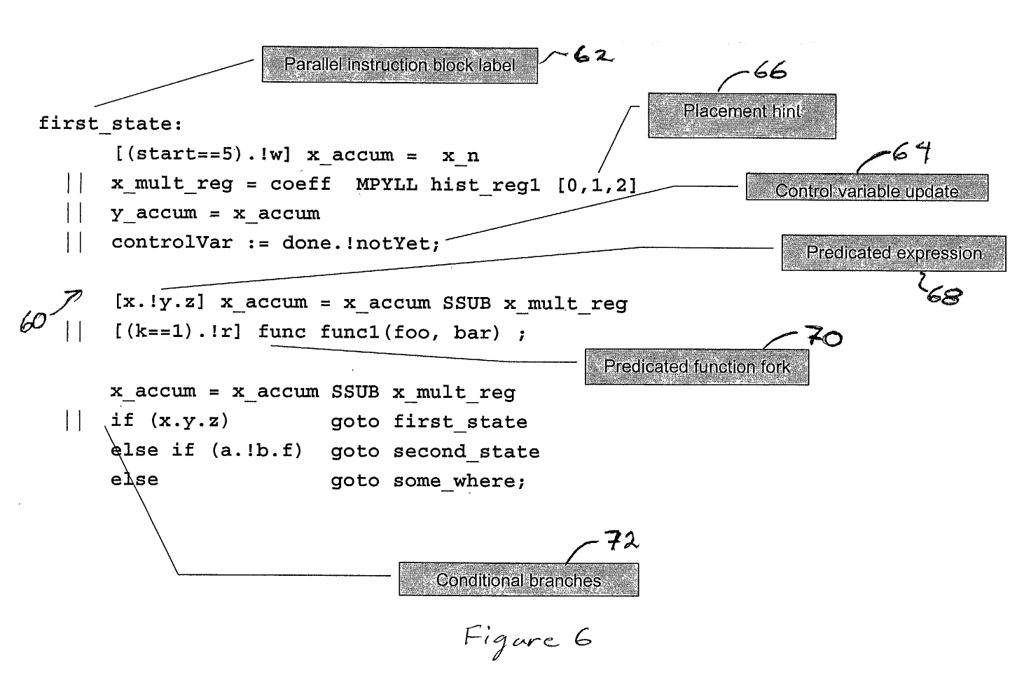

Referring to FIG. 6, an example of the high-level language code 60 showing the different types of commands for the interface 20 is shown. The code 60 has parallel instruction block label 62 which labels the code. Within the code, an update of the control variables 64 occurs as well as a placement hint 66. The code 60 further includes a predicated expression 68 as well as a predicated function fork 70. Finally, conditional branches 72 are included. The code 60 is entered into the interface 20 which synthesizes the control and datapath routes for the RCP 10. Accordingly, the interface 20 is operative to determine the code which is run on the RCP 10. The interface 20 is operative to synthesize the control and datapath by mapping the code 60 to corresponding code which can be run on the RCP 10.

Additional modifications and improvements of the present invention may also be apparent to hose of ordinary skill in the art. Thus, the particular combination of parts described and illustrated herein is intended to represent only certain embodiments of the present invention, and is not intended to serve as limitations of alternative devices within the spirit and scope of the invention.

1. A computer implemented method for the automatic compilation of a computer program written in a high level programming language into a program for execution by a reconfigurable processing system with a processor, the method comprising the steps of:
automatically determining a set of instructions to be executed by the reconfigurable processing system that will result in the optimization of the execution of the computer program written for execution by the processor; and
generating executable code for the reconfigurable processing system with the instructions.

2. The method of claim 1 wherein determining the set of instructions comprises generating a set of data computation commands that are processed by the reconfigurable processing system.

3. The method of claim 2 wherein the set of data computation commands are generated for operation on the processor of the reconfigurable processing system.

4. The method of claim 3 wherein the data computation commands generated are operable to perform computations on the processor of the reconfigurable processing system.

5. The method of claim 1 wherein determining the set of instructions comprises generating a set of data storage and access commands for loading and storing instructions onto the reconfigurable processing system.

6. The method of claim 5 wherein generating the data storage and access commands instruct how data is to be supplied to the processor of the reconfigurable processing system.

7. The method of claim 6 wherein the set of data storage and access commands are load/store instructions for the processor.

8. The method of claim 7 wherein the generated data storage and access commands include commands which operate address generators, comparators, interconnects, rams and registers of the reconfigurable processing system.

9. The method of claim 1 wherein determining the set of instructions comprises generating a set of control flow commands to sequence data computations in parallel through the processing system in response to data computation and data storage and access commands.

10. The method of claim 9 wherein the generated set of control flow commands are operative as state machines in the processor of the reconfigurable processing system.

11. The method of claim 1 wherein determining a set of instructions comprises:
generating a set of data computation commands that are processed by the reconfigurable processing system;
generating a set of data storage and access commands for loading and storing instructions onto the reconfigurable processing system; and
generating a set control flow commands to sequence data computations in parallel through the reconfigurable processing system in response to the data computation commands and the data storage and access commands.

12. A method of generating an assembly language that generates an executable code that can be run on a reconfigurable processing system having a processor, the method comprising the steps of:
a) generating a set of data computation commands that are processed by the reconfigurable processing system;
b) generating a set of data storage and access commands for loading and storing instructions onto the reconfigurable processing system; and
c) generating a set of control flow commands to sequence data computations in parallel through the processing system in response to the data computation commands and the data storage and access commands.

13. The method of claim 12 wherein step (a) comprises generating a set of data computation commands are generated for operation on the processor of the reconfigurable processing system.

14. The method of claim 13 wherein the data computation commands generated are operable to perform computations on the processor of the reconfigurable processing system.

15. The method of claim 12 wherein step (b) comprises generating data storage and access commands which instruct how data is to be supplied to the processor of the reconfigurable processing system.

16. The method of claim 15 wherein the generated data storage and access commands are load/store instructions for the processor.

17. The method of claim 16 wherein the generated data storage and access commands include commands which operate address generators, comparators, interconnects, rams and registers of the reconfigurable processing system.

18. The method of claim 12 wherein step (c) comprises generating a set of control flow commands which are operative as state machines in the processor of the reconfigurable processing system.
